(19) United States
(12) Patent Application Publication
(10) Pub. No.: US 2022/0396713 A1
(43) Pub. Date: Dec. 15, 2022

(54) PULVERULENT COMPOSITION FOR THE MANUFACTURE OF ARTICLES WITH A METALLIC APPEARANCE, WHICH IS STABLE OVER TIME AND SHOWS IMPROVED RESISTANCE TO METAL MARKING

(71) Applicant: Arkema France, Colombes (FR)

(72) Inventors: Gregory FILOU, Manneville sur Risle (FR); Cyrille MATHIEU, Rouen (FR)

(73) Assignee: Arkema France, Colombes (FR)

(21) Appl. No.: 17/681,333

(22) Filed: Feb. 25, 2022

Related U.S. Application Data
(63) Continuation of application No. 13/003,438, filed on Jun. 13, 2011, now abandoned.

(30) Foreign Application Priority Data
Jul. 10, 2008 (FR) 0854698

(51) Int. Cl. C09D 177/02; C09D 7/40; C09D 5/03; A47L 15/50; C09D 7/61; C09D 7/62

(52) U.S. Cl. CPC C09D 177/02; C09D 7/70; C09D 5/032; A47L 15/50; C09D 7/61; C09D 7/62; Y10T 428/31678; C08L 77/02

(57) ABSTRACT

A pulverulent composition for the manufacture of articles having a metallic appearance that is stable over time and an improved resistance to penciling, the composition including: from 50 to 99.9% by weight of at least one thermoplastic polymer, from 0.1 to 5% by weight of at least one effect pigment, from 0 to 0.3% by weight of at least one metallic pigment relative to the total weight of the composition.

### CROSS REFERENCE TO RELATED APPLICATIONS

The present application is a continuation of U.S. application Ser. No. 13/003,438, filed on Jan. 10, 2011, which is a U.S. national stage of International Application No. PCT/FR2009/051378, filed on Jul. 10, 2009, which claims the benefit of French Application No. 0854698, filed on Jul. 10, 20008. The entire contents of each of U.S. application Ser. No. 13/003,438, International Application No. PCT/FR2009/051378, and French Application No. 0854698 are hereby incorporated herein by reference in their entirety.

### TECHNICAL FIELD

The invention relates to the field of pulverulent polymer compositions used for the manufacture of articles with a metallic appearance. More particularly, the invention relates to the manufacture of at least one surface part (i.e. at least an outer surface) of an article by powder aggregation by melting at least one coat of powder.

The present invention relates not only to the total manufacture of three-dimensional articles but also to the manufacture of at least one surface part of these articles, once this manufacture is performed by aggregating at least one coat of powder by melting or sintering mediated by radiation. The term “radiation” means, for example, a laser beam (laser sintering), infrared radiation or UV radiation, or any source of electromagnetic radiation that can melt the powder to manufacture a 3D article or at least a surface part of the article, such as a coating on the article.

Consequently, the present invention relates especially to the field of polymer coatings for covering articles such as metal baskets of dishwashers. These coatings form a film on the article, arising from the melting of at least one film of powder deposited beforehand on the article.

These coatings are produced at the industrial scale by electrostatic dusting, by dipping in a fluidized bed, by dipping in a triboelectric bed (as described in patent EP 1 119 422) or via any other coating process that is well known to those skilled in the art.

Known Art

Document U.S. Pat. No. 5,520,956 (Merck) describes the use of pigments with glossy effects in coatings obtained by crosslinking (thermosetting).

Document US 2007/0032574 (Eckart) describes the use of nacreous pigments whose surface is modified with an organophosphorus compound, in coating powders. The coating powders used are polyesters, polyurethanes, polyacrylates or epoxy resins.

This type of polymer coating has several drawbacks: insufficient abrasion resistance, insufficient corrosion resistance, and complicated implementation that requires crosslinking in an oven under precise time and temperature conditions.

Mention may also be made of the coatings obtained with thermoplastic polyolefin powders (for example based on polyethylene or polypropylene), comprising a polar function, for example from (meth)acrylic acid, as described in document GB 2 097 809 from the company Plascoat. However, these coatings have insufficient abrasion resistance and corrosion strength, and are difficult to use on articles made of metal wires such as dishwasher baskets.

Conversely, polyamide coatings show good abrasion resistance, good corrosion resistance and are very easy to use. Patents EP 0 367 653, EP 0 706 544, EP 0 821 039, EP 1 453 906, EP 1 541 650 and patent application WO 2008/029070 filed by the Applicant describe these advantageous properties obtained with polyamide coatings.

The defects most frequently encountered in the coatings of the prior art are pitting, blistering, fish eyes, edge stripping and orange-peel skin.

Pitting corresponds to the formation of holes at the surface of a coating caused by a defect in the spreading of the polymer film when it forms a film and hardens. Blistering corresponds to the formation of blisters at the surface of the polymer film. Fish eyes are imperfections characterized by the disappearance of the coating at certain areas on the surface of the film. Fish eyes are generally formed when the coating cannot sufficiently wet the surface or when the polymer particles coalesce together poorly. The molten coating forms a moiety that resembles fish eyes. The defect of covering the edges or edge stripping is associated with poor covering by the polymer film of the extremities of articles. Another possible aspect defect is orange-peel skin, i.e. excessive surface waviness of the coating, caused by poor tautness of the polymer film.

In addition to being unattractive, these defects lead to corrosion problems.

It also arises that certain coatings and surfaces of articles undergo a loss of hue or yellowing.

Now, a strong market trend is the demand for coatings that combine high anticorrosion properties and an improved esthetic appearance, in particular a metallic appearance, for example of silvery, golden or iridescent color.

In order to improve the metallic appearance of the coating films, metallic pigments are used in the formulation of the coatings.

US patent application US 2006/0135670 describes a thermoplastic polymer composition containing metal powders, such as stainless steel powders, to obtain a coating of metallic appearance. The amount of metal powder used in this application is within the range from 1 to 10 parts and preferably in the range from 1 to 3 parts per 100 parts (by mass) of thermoplastic polymer.

The problems typically observed on these coatings comprising metal pigments are a loss of the metallic effect, and tarnishing of the coatings, during their prolonged contact with water. Certain amphoteric metals react in aqueous medium to form chemical species, leading to the tarnishing of the metal particles and thus of the coating during use.

To reduce this problem of tarnishing, one current means consists in using a water-impermeable matrix or in using metal particles (for example aluminum) that are coated, for example with silica. This is especially the case for non-leafing aluminum. However, these means do not afford the required esthetic aspect.

Another problem is that of the fragility of the coating with respect to hydrolysis. When compared with other thermoplastic polymers, polyamide (PA), in particular polyamide 11, shows better resistance to hydrolysis and to corrosion and to abrasion, and it is easy to use (for example by dipping in a fluidized bed). This crystalline polyamide thus forms a barrier material that is particularly suited for coating dishwasher baskets.

Another problem is the separation of pigments when they are added by dry blending to the composition. The problem of separation of pigments during application is mainly associated with the presence of electrostatic forces that tend to separate the polymer and the pigment. To avoid this problem, it is necessary to select a particle size suited to the pigment and a sufficient mixing time.

The major problem of metal coatings is their tendency to become marked following the rubbing of the article on any surface. This may be the case especially when coated items are transported.

This problem cannot be solved by using a topcoat, since this coat would be impaired during the remelting of the polymer, in the course of the coating process.

The capacity of a coating or of a surface of an article to become marked with a deep scratch, following the rubbing of the article, especially a metallic article, is known as “metal marking”.

Although they do not impair the polymer matrix deep down, the slightest friction of the surface of the coating of the article results in unattractive dark lines, which are all the more visible at the surface of the film when this film has a light hue. The marks accumulate on the coating on each use of the article, and occasionally even before its use, during maintenance, handling or transportation of the article, such that the coating rapidly loses its original attractive appearance.

One aim of the present invention is thus to avoid the abovementioned surface or coating defects and to improve the resistance to metal marking of the polymer coatings and/or of the surface polymeric parts of articles with a metallic appearance.

An aim of the present invention is also to provide a composition for manufacturing (at least partially) a 3D article, and/or a composition for coating an article, which can produce a coating film or at least a surface part of the article, whose metallic appearance and color remain homogeneous, attractive and stable over time, i.e. do not change even after several friction actions and/or uses of the article.

An aim of the present invention is also to provide a polymer coating with improved resistance to metal marking, and also a covering process for obtaining such a coating.

The Applicant has now found that the use of pigments with effects, such as nacres, in effective amount in a powder composition, especially a coating composition, for the manufacture of an article, combined with the limitation of the content of metallic pigments, especially aluminum pigments, makes it possible to prevent and even to avoid the appearance of metal marking at the surface of the article or of the coating film, while at the same time affording an improvement in the esthetic appearance, and especially the metallic appearance, of the article or of its coating.

### SUMMARY

One subject of the present invention is thus a pulverulent composition for the manufacture of articles with a metallic appearance that is stable over time and improved resistance to metal marking, said composition comprising:
from 50% to 99.9% by mass of at least one thermoplastic polymer,
from 0.1% to 5% by mass of at least one pigment with an optical effect,
from 0 to 0.3% by mass of at least one metallic pigment, based on the total mass of the composition.

The expression “articles with a metallic appearance that is stable over time” means articles whose metallic surface does not have the abovementioned drawbacks or defects, in particular metal marking, and these defects do not arise over time either, even during the use of these articles.

The pulverulent composition according to the invention may, of course, also comprise up to 49.9% of one or more other component(s) chosen from polymers other than thermoplastics, fillers, additives, standard monochromatic pigments or any other material that may be envisioned in such a pulverulent composition.

Advantageously, said at least one base polymer comprises polyamide, preferably chosen from the polyamides: PA 11, PA 12, PA 6.10, PA 6.12, PA 6.14, PA 6.18, PA 10.10, PA 10.12, copolyamides and mixtures thereof.

Advantageously, said at least one pigment with an effect is chosen from diffractive pigments, interference pigments and reflective pigments, and mixtures thereof.

Advantageously, the diffractive pigments are chosen from:
monolayer pigments comprising a reflective material chosen from metals and alloys thereof,
pigments with a multilayer structure comprising a layer of a reflective material chosen from metals and alloys thereof and also from non-metallic reflective materials, covered on at least one side with a layer of a dielectric material,
pigments composed of a preformed dielectric or ceramic material such as a natural lamellar mineral or synthetic lamellae, and mixtures thereof.

Advantageously, said interference pigments are chosen from nacres, reflective interference particles and goniochromatic pigments, and mixtures thereof.

Advantageously, said goniochromatic pigments are chosen from multilayer interference structures and liquid-crystal coloring agents.

Advantageously, said nacres are chosen from nacreous pigments such as titanium mica coated with an iron oxide, mica coated with bismuth oxychloride, titanium mica coated with chromium oxide, titanium mica coated with an organic dye, nacreous pigments based on bismuth oxychloride, mica particles on the surface of which are superposed at least two successive layers of metal oxides and/or of organic dyestuffs, and mixtures thereof.

Advantageously, said reflective interference particles are chosen from particles with a synthetic substrate coated at least partially with at least one layer of at least one metal oxide.

Advantageously, said reflective pigments are chosen from:
metal oxides, especially titanium or iron oxides obtained by synthesis,
multilayer structures comprising a natural or synthetic substrate, at least partially coated with at least one layer of a reflective material, especially of at least one metal or metallic material.

Advantageously, said at least one metallic pigment is chosen from: aluminum, copper, copper or aluminum alloys, and mixtures thereof.

Advantageously, said aluminum is leafing aluminum.

Advantageously, said at least one polymer is polyamide 11, said at least one pigment with an effect comprises from 0.1% to 1% by mass of nacres relative to the total mass of the composition, said at least one metallic pigment comprises less than 0.3% by mass of aluminum and preferably less than 0.2% by mass of aluminum relative to the total mass of the composition.

Advantageously, said composition also comprises at least one additive and/or at least one filler and/or at least one monochromatic pigment.

Advantageously, said at least one additive is chosen from antioxidants, heat stabilizers, anticorrosion agents, fluidity or flowability enhancers, film-forming agents, film-forming auxiliaries, gums, semicrystalline polymers, preserving agents and UV stabilizers, and mixtures thereof.

Advantageously, said at least one filler is chosen from oxides, silicas, quartz, amorphous silica, diatomaceous earths; silicates, talc, mica, kaolin, bentonite, calcium silicate, trimethyl siloxysilicate; carbonates, calcium carbonate, magnesium carbonate, magnesium hydrogen carbonate, dolomite; sulfates; hydroxyapatite, boron nitride, hollow silica microspheres; glass or ceramic microcapsules; composites of silica and of titanium dioxide, and mixtures thereof.

A subject of the invention is also a coating of metallic appearance that is stable over time and resistant to metal marking, said coating being derived from the melting of at least one coat of powder composition as defined previously.

A subject of the invention is also a process for manufacturing at least a surface part of an article by powder melt-aggregation, said powder comprising a composition according to the invention as defined previously.

Advantageously, the powder melt-aggregation is brought about by electromagnetic radiation, such as a laser beam, infrared radiation or UV radiation.

Advantageously, said surface part of the article comprises at least one coating formed by powder aggregation of composition according to the invention, said coating having a metallic appearance that is stable over time and that is resistant to metal marking, said process comprising at least the following steps:
mixing of the components of said composition, preferably at a spin speed in the range from 500 to 3000 rpm,
screening of the powder thus obtained,
heating of at least one surface of the article to be covered,
at least partially dipping the article in said composition,
cooling in air and/or with water of the article thus covered.

A subject of the invention is also the use of a composition according to the invention as defined previously, for the manufacture of articles with a metallic appearance that is stable over time, and in particular for improving the resistance to metal marking of these articles. A subject of the invention is especially the use of a composition according to the invention for the manufacture of coatings, paints, anticorrosion compositions, composite multilayer materials, articles obtained via powder melt-aggregation or sintering techniques brought about by electromagnetic radiation, packaging, toys, textiles, decorative components, motor vehicles, aeronautics, household electrical goods and/or electronics.

A subject of the invention is also a manufactured article having at least a surface part of metallic appearance that is stable over time and that shows improved resistance to metal marking, said surface part being obtained by melting at least one coat of powder composition as defined previously.

Advantageously, said article comprises a coating obtained from a powder composition according to the invention.

A subject of the present invention is also a dishwasher basket comprising a coating obtained from a powder composition according to the invention, as defined previously.

### BRIEF DESCRIPTION OF THE FIGURES

FIG. 1 shows a metal-marking resistance test device as used in the examples.

FIG. 2 shows a reference scale which attributes a grade to each level of metal marking.

### DETAILED DESCRIPTION

The composition according to the invention serves for the manufacture of articles according to a layer-by-layer powder aggregation process, and serves especially to cover and/or protect all kinds of articles, especially metallic articles, such as those made of aluminum, aluminum alloys, steel and alloys thereof, etc. The invention is particularly useful for articles made of metal wire, for example the metal baskets of dishwashers. The composition of the invention, in the form of a coating, may also cover non-metallic articles, such as wood, plastic or ceramic.

The composition of the invention comprises a base polymeric substance, which is especially thermoplastic, and which is generally in the form of powder, and also pigments with effects, such as nacres. The composition according to the invention may also comprise an amount of metallic pigments not exceeding 0.3% of the total mass of the composition, and/or standard dyestuffs such as standard monochromatic pigments.

I—Polymers

As examples of polymers that are suitable for the composition of the invention, mention may be made of polyamides (homopolyamides and copolyamides), polyolefins, epoxy and polyesters, epoxy/polyether hybrids and polyurethanes.

The term “polyamide” (homopolyamide or copolyamide abbreviated as CoPA) means the products of polymerization or condensation of the same monomer (in the case of homopolyamides) or of several different monomers (in the case of CoPA) chosen from:
monomers of amino acid or aminocarboxylic acid type, and preferably α,ω-aminocarboxylic acids;
monomers of lactam type containing from 3 to 18 carbon atoms on the main ring, and which may be substituted;
monomers of “diamine-diacid” type derived from the reaction between an aliphatic diamine containing between 4 and 18 carbon atoms and a dicarboxylic acid containing between 4 and 18 carbon atoms; and
mixtures thereof, with monomers having a different number of carbons in the case of copolyamides formed by blends between a monomer of amino acid type and a monomer of lactam type.

In the present description of copolyamides, the term “monomer” should be taken in the sense of a “repeating unit”. Specifically, the case in which a repeating unit of the PA is formed from the combination of a diacid with a diamine is particular. It is considered that it is the combination of a diamine and a diacid, i.e. the diamine-diacid couple (in equimolar amount), which corresponds to the monomer. This is explained by the fact that, individually, the diacid or the diamine is only a structural unit, which by itself is insufficient to polymerize.

Monomers of Amino Acid Type:

Examples of α,ω-amino acids that may be mentioned include those containing from 4 to 18 carbon atoms, such as aminocaproic acid, 7-aminoheptanoic acid, 11-aminoundecanoic acid, 11-n-heptylaminoundecanoic acid and 12-aminododecanoic acid.

Monomers of Lactam Type:

Examples of lactams that may be mentioned include those containing from 3 to 18 carbon atoms on the main ring and which may be substituted. Examples that may be mentioned include β,β-dimethylpropiolactam, α,α-dimethylpropiolactam, amylolactam, caprolactam, also known as lactam 6, capryllactam, also known as lactam 8, oenantholactam, 2-pyrrolidone and lauryllactam, also known as lactam 12.

Monomers of “Diamine-Diacid” Type:

Examples of dicarboxylic acids that may be mentioned include acids containing between 4 and 18 carbon atoms. Examples that may be mentioned include adipic acid, sebacic acid, azelaic acid, suberic acid, isophthalic acid, butanedioic acid, 1,4-cyclohexanedicarboxylic acid, terephthalic acid, the sodium or lithium salt of sulfoisophthalic acid, dimerized fatty acids (these dimerized fatty acids have a dimer content of at least 98% and are preferably hydrogenated) and dodecanedioic acid HOOC—(CH₂)₁₀—COOH.

Examples of diamines that may be mentioned include aliphatic diamines containing from 4 to 18 atoms, which may be aryl and/or saturated cyclic diamines. Examples that may be mentioned include hexamethylenediamine, piperazine, tetramethylenediamine, octamethylenediamine, decamethylenediamine, dodecamethylenediamine, 1,5-diaminohexane, 2,2,4-trimethyl-1,6-diaminohexane, diamine polyols, isophorone diamine (IPD), methylpentamethylenediamine (MPDM), bis(aminocyclohexyl)methane (BACM), bis(3-methyl-4-aminocyclohexyl)methane (BMACM), meta-xylylenedia mine, bis(p-aminocyclohexyl)methane and trimethylhexamethylenediamine.

Examples of monomers of “diamine-diacid” type that may be mentioned include those resulting from the condensation of hexamethylenediamine with a C6 to C36 diacid, especially the monomers: 6.6, 6.10, 6.11, 6.12, 6.14, 6.18. Mention may be made of monomers resulting from the condensation of decanediamine with a C6 to C36 diacid, especially the monomers: 10.10, 10.12, 10.14, 10.18; or resulting from the condensation of decanediamine with a terephthalic acid, i.e. the monomer 10.T.

As examples of copolyamides formed from the various types of monomers described above, mention may be made of copolyamides resulting from the condensation of at least two α,ω-aminocarboxylic acids or from two lactams or from one lactam and one α,ω-aminocarboxylic acid. Mention may also be made of copolyamides resulting from the condensation of at least one α,ω-aminocarboxylic acid (or a lactam), at least one diamine and at least one dicarboxylic acid. Mention may also be made of copolyamides resulting from the condensation of an aliphatic diamine with an aliphatic dicarboxylic acid and at least one other monomer chosen from aliphatic diamines different than the preceding one and aliphatic diacids different than the preceding one.

Examples of copolyamides that may be mentioned include copolymers of caprolactam and of lauryllactam (PA 6/12), copolymers of caprolactam, of hexamethylenediamine and of adipic acid (PA 6/6.6), copolymers of caprolactam, of lauryllactam, of hexamethylenediamine and of adipic acid (PA 6/12/6.6), copolymers of caprolactam, of hexamethylenediamine and of azelaic acid, of 11-aminoundecanoic acid, and of lauryllactam (PA 6/6.9/11/12), copolymers of caprolactam, of adipic acid and of hexamethylenediamine, of 11-aminoundecanoic acid, of lauryllactam (PA 6/6.6/11/12), copolymers of hexamethylenediamine, of azelaic acid and of lauryllactam (PA 6.9/12), copolymers of 2-pyrrolidone and of caprolactam (PA 4/6), copolymers of 2-pyrrolidone and of lauryllactam (PA 4/12), copolymers of caprolactam and of 11-aminoundecanoic acid (PA 6/11), copolymers of lauryllactam and of capryllactam (PA 12/8), copolymers of 11-aminoundecanoic acid and of 2-pyrrolidone (PA 11/4), copolymers of capryllactam and of caprolactam (PA 8/6), copolymers of capryllactam and of 2-pyrrolidone (PA 8/4), copolymers of lauryllactam and of capryllactam (PA 12/8), copolymers of lauryllactam and of 11-aminoundecanoic acid (PA 12/11).

Substances that are particularly preferred are polyamide 11 and polyamide 12, and also polyamides and copolyamides especially using the monomers 6.10, 6.12, 6.14, 6.18, 10.10 and 10.12.

Although, in accordance with one preferred embodiment of the invention, the present invention is generally described in the rest of the text with reference to a PA 11 powder (which has the additional advantage of being of renewable origin), the invention is obviously not limited to PA 11 powders. The present invention includes any PA (homopolyamide or copolyamide) powder in which the particles have a granulometry of between 5 and 1000 μm and preferably between about 40 and 160 μm.

As examples of commercially available polyamide rates that are particularly suitable for the present invention, mention may be made of products of the brand name Rilsan® based on PA 11 from the company Arkema, such as: Rilsan® T Silver 9103, Rilsan® T Silver 9108.

The preferred particle diameters are substantially close to 100 μm (median diameter d50).

The term “polyolefins” means polymers comprising olefin units, for instance ethylene, propylene, 1-butene, etc. units. Examples that may be mentioned include:
polyethylene, propylene, copolymers of ethylene with α-olefins. These products may be grafted with unsaturated carboxylic acid anhydrides such as maleic anhydride or unsaturated epoxides such as glycidyl methacrylate;
copolymers of ethylene with at least one product chosen from (i) unsaturated carboxylic acids, salts thereof and esters thereof, (ii) vinyl esters of saturated carboxylic acids, (iii) unsaturated dicarboxylic acids, salts thereof, esters thereof, hemiesters thereof and anhydrides thereof, (iv) unsaturated epoxides. These ethylene copolymers may be grafted with unsaturated dicarboxylic acid anhydrides or unsaturated epoxides.

II—Pigments

A pigment is a dyestuff and/or a material that gives a “metallic” or “iridescent” aspect, which is in the form of a powder (colored, white or black), and is insoluble, in contrast to “dyes” strictly speaking, in solvents and substrates.

Pigments with an Effect

A composition according to the invention comprises at least one pigment with an effect chosen from diffractive pigments, interference pigments, such as nacres, and reflective pigments, and mixtures thereof.

The term “pigment with an effect” refers to any material with a specific optical effect. This effect is different than a simple conventional hue effect, i.e. a unified and stabilized effect as produced by standard dyestuffs, for instance monochromatic pigments. For the purposes of the invention, the term “stabilized” means lacking an effect of variability of the color as a function of the angle of observation or alternatively in response to a temperature change.

For example, this material may be chosen from particles with a metallic tint, goniochromatic coloring agents, diffractive pigments, thermochromic agents, optical brighteners, and also fibers, especially interference fibers. Needless to say, these various materials may be combined so as to simultaneously afford two effects, or even a novel effect in accordance with the invention.

The pigments with an effect that may be included in the composition of the invention are preferably chosen from diffractive pigments, interference pigments and reflective pigments, and mixtures thereof. They may be present in the composition according to the invention in a content ranging from 0.1% to 10% by mass, preferably ranging from 0.1% to 5% by mass and better still from 0.1% to 1% by mass relative to the total mass of the composition.

In particular, said at least one pigment with an effect is present in a content of greater than or equal to 0.1% by mass, preferably greater than or equal to 0.2% by mass and better still substantially equal to 0.3% by mass relative to the total mass of the composition.

1—Interference Pigment

The term “interference pigment” denotes a pigment capable of producing a color via an interference phenomenon, for example between the light reflected by a plurality of superposed layers with different refractive indices, especially a succession of layers with high and low refractive indices.

An interference pigment may, for example, comprise more than four layers with different refractive indices.

The layers of the interference pigment may or may not surround a core, which may or may not have a flattened shape.

Nacres are examples of interference pigments.

Nacres

The term “nacre” should be understood as meaning colored particles of any form, which may or may not be iridescent, especially produced by certain mollusks in their shell, or alternatively synthesized, and which have a color effect via optical interference.

Examples of nacres that may be mentioned include nacreous pigments such as titanium mica coated with an iron oxide, mica coated with bismuth oxychloride, titanium mica coated with chromium oxide, titanium mica coated with an organic dye especially of the abovementioned type, and also nacreous pigments based on bismuth oxychloride. They may also be mica particles at the surface of which are superposed at least two successive layers of metal oxides and/or of organic dyestuffs.

Among the nacres that are commercially available, mention may be made of the nacres sold by the company BASF, by the company Merck, by the company Eckart and by the company Engelhard.

The nacres may more particularly have a yellow, pink, red, bronze, orange, brown, grey, silver, coppery, metallic and/or moiré color or tint.

As illustrations of nacres that may be introduced as interference pigments into the composition of the invention, mention may be made of the gold-colored nacres sold especially by the company Engelhard under the name Brilliant gold 212G (Timica), Gold 222C (Cloisonne), Sparkle gold (Timica), Gold 4504 (Chromalite) and Monarch gold 233X (Cloisonne); the bronze nacres sold especially by the company Merck under the name Bronze fine (17384) (Colorona) and Bronze (17353) (Colorona) and by the company Engelhard under the name Super bronze (Cloisonne); the orange nacres sold especially by the company Engelhard under the name Orange 363C (Cloisonne) and Orange MCR 101 (Cosmica) and by the company Merck under the name Passion orange (Colorona) and Matte orange (17449) (Microna); the brown nacres sold especially by the company Engelhard under the name Nu-antique copper 340XB (Cloisonne) and Brown CL4509 (Chromalite); the nacres with a copper tint sold especially by the company Engelhard under the name Copper 340A (Timica); the nacres with a red tint sold especially by the company Merck under the name Sienna fine (17386) (Colorona); the nacres with a yellow tint sold especially by the company Engelhard under the name Yellow (4502) (Chromalite); the red nacres with a gold tint sold especially by the company Engelhard under the name Sunstone G012 (Gemtone); the pink nacres sold especially by the company Engelhard under the name Tan opale G005 (Gemtone); the black nacres with a gold tint sold especially by the company Engelhard under the name Nu antique bronze 240 AB (Timica), the blue nacres sold especially by the company Merck under the name Matte blue (17433) (Microna), the white nacres with a silvery tint sold especially by the company Merck under the name Xirona Silver, and the golden-green pink-orange nacres sold especially by the company Merck under the name Indian summer (Xirona), and mixtures thereof.

A dyestuff chosen from nacres, in particular micas covered with at least one layer of metal oxide, is preferably used.

Reflective Interference Particles

These particles may be chosen from particles with a synthetic substrate coated at least partially with at least one layer of at least one metal oxide, chosen, for example, from titanium oxides, especially TiO₂, iron oxide, especially Fe₂O₃, tin oxide, chromium oxide, barium sulfate and the following materials: MgF₂, CrF₃, ZnS, ZnSe, SiO₂, Al₂O₃, MgO, Y₂O₃, SeO₃, SiO, HfO₂, ZrO₂, CeO₂, Nb₂O₅, Ta₂O₅ and MoS₂, and mixtures or alloys thereof.

As examples of such particles, mention may be made, of particles comprising a synthetic mica substrate coated with titanium dioxide, or glass particles coated with brown iron oxide, titanium oxide, tin oxide or a mixture thereof, for instance those sold under the brand name Reflecks® by the company Engelhard.

Goniochromatic Pigment

For the purposes of the present invention, the term “goniochromatic pigment” means a pigment for obtaining, when the composition is spread onto a support, a color trajectory in the plane a*b* of the CIE 1976 colorimetric space that corresponds to a variation Dh° of the angle of hue h° of at least 20° when the angle of observation is varied relative to the normal between 0° and 80°, for an angle of light incidence of 45°.

The color trajectory may be measured, for example, using an Instrument Systems brand spectrogonioreflectometer of reference GON 360 Goniometer, after the first composition has been spread in fluid form to a thickness of 300 μm using an automatic spreader onto an Erichsen brand contrast card of reference Typ 24/5, the measurement being taken on the black background of the card.

The goniochromatic pigment may be chosen, for example, from multilayer interference structures and liquid-crystal coloring agents.

In the case of a multilayer structure, it may comprise, for example, at least two layers, each layer being made, for example, from at least one material chosen from the group consisting of the following materials: MgF₂, Ce F3, ZnS, ZnSe, Si, SiO₂, Ge, Te, Fe₂O₃, Pt, Va, Al₂O₃, MgO, Y₂O₃, S₂O₃, SiO, HfO₂, ZrO₂, CeO₂, Nb₂O₅, Ta₂O₅, TiO₂, Ag, Al, Au, Cu, Rb, Ti, Ta, W, Zn, MoS₂, cryolite, alloys and polymers, and combinations thereof.

The multilayer structure may or may not have, relative to a central layer, symmetry regarding the chemical nature of the stacked layers. Different effects are obtained depending on the thickness and the nature of the various layers.

Examples of symmetrical multilayer interference structures are, for example, the following structures: Fe₂O₃/SiO₂/Fe₂O₃/SiO₂/Fe₂O₃, a pigment having this structure being sold under the name Sicopearl by the company BASF; MoS₂/SiO₂/mica-oxide/SiO₂/MoS₂; Fe₂O₃/SiO₂/mica-oxide/SiO₂/Fe₂O₃; TiO₂/SiO₂/TiO₂ and TiO₂/Al₂O₃/TiO₂, pigments having these structures being sold under the name Xirona by the company Merck (Darmstadt).

The liquid-crystal coloring agents comprise, for example, silicones or cellulose ethers on which are grafted mesomorphic groups. Liquid-crystal goniochromatic particles that may be used, for example, are those sold by the company Chenix and also those sold under the name Helicone® HC by the company Wacker.

Goniochromatic pigments that may also be used include certain nacres, pigments with effects on synthetic substrate, especially a substrate of alumina, silica, borosilicate, iron oxide or aluminum type, or interference holographic flakes derived from a polyterephthalate film.

The material may also comprise dispersed goniochromatic fibers. Such fibers may be less than 80 μm long, for example.

2—Diffractive Pigment

For the purposes of the present invention, the term “diffractive pigment” denotes a pigment capable of producing a color variation according to the angle of observation when lit with white light, on account of the presence of a structure that diffracts light. Such a pigment is also occasionally known as a holographic pigment.

A diffractive pigment may comprise a diffracting network capable, for example, of diffracting an incident monochromatic light ray in defined directions.

The diffraction network may comprise a periodic unit, especially a line, the distance between two adjacent units being of the same order of magnitude as the wavelength of the incident light.

When the incident light is polychromatic, the diffraction network will separate the various spectral components of the light and produce a rainbow effect.

Reference may appropriately be made regarding the structure of diffractive pigments to the article “Pigments Exhibiting Diffractive Effects” by Alberto Argoitia and Matt Witzman, 2002, Society of Vacuum coaters, 45th Annual Technical Conference Proceedings 2002.

The diffractive pigment may be made with units having different profiles, especially triangular, symmetrical or non-symmetrical, in gaps, of constant or non-constant width, sinusoidal, in ladder form.

The spatial frequency of the network and the depth of the units will be chosen as a function of the degree of separation of the various orders desired. The frequency may range, for example, between 500 and 3000 lines per mm.

Preferably, the particles of the diffractive pigment each have a flattened form, and are especially in the form of platelets.

The same pigment particle may comprise two crossed, perpendicular or non-perpendicular diffraction networks, of identical or different ruling.

The diffractive pigment may have a multilayer structure comprising a layer of a reflective material, covered at least on one side with a layer of a dielectric material. The latter material may give the diffractive pigment better rigidity and durability. The dielectric material may thus be chosen, for example, from the following materials: MgF₂, SiO₂, Al₂O₃, AlF₃, CeF₃, LaF₃, NdF₃, SmF₂, BaF₂, CaF₂, LiF and combinations thereof. The reflective material may be chosen, for example, from metals and alloys thereof, and also from non-metallic reflective materials. Among the metals that may be used, mention may be made of Al, Ag, Cu, Au, Pt, Sn, Ti, Pd, Ni, Co, Rd, Nb, Cr and Fe, and materials, combinations or alloys thereof, and doping products thereof with rare-earth metals.

Such a reflective material may, by itself, constitute the diffractive pigment, which will then be monolayer.

As a variant, the diffractive pigment may comprise a multilayer structure comprising a core of a dielectric material covered with a reflective layer at least on one side, or even totally encapsulating the core. A layer of a dielectric material may also cover the reflective layer(s). The dielectric material used is then preferably mineral, and may be chosen, for example, from metal fluorides, metal oxides, metal sulfides, metal nitrides, and metal carbides, and combinations thereof. The dielectric material may be in crystalline, semi-crystalline or amorphous form. In this configuration, the dielectric material may be chosen, for example, from the following materials: MgF₂, SiO, SiO₂, Al₂O₃, TiO₂, WO, AlN, BN, B₄C, WC, TiC, TiN, N₄Si₃, ZnS, glass particles and carbons of diamond type, and combinations thereof.

As a variant, the diffractive pigment may be composed of a preformed dielectric or ceramic material such as a mineral in natural lamellar form, for example mica perovskite or talc, synthetic lamellae formed from glass, alumina, SiO₂, carbon, an iron oxide/mica, mica coated with BN, BC, graphite or bismuth oxychloride, and combinations thereof.

Instead of a layer of a dielectric material, other materials that improve the mechanical properties may be suitable for use. Such materials may comprise silicone, metal silicides, semiconductive materials formed from elements of groups III, IV and V, metals with a cubic-centered crystal structure, cermet compositions or materials and semiconductive glasses, and various combinations thereof.

The diffractive pigment used may be chosen especially from those described in the American patent application US 2003/0031870 published on Feb. 13, 2003.

A diffractive pigment may comprise, for example, the following structure: MgF₂/Al/MgF₂, a diffractive pigment having this structure being sold under the name Spectraflair 1400 Pigment Silver by the company Flex Products, or Spectraflair 1400 Pigment Silver FG. The weight proportion of MgF₂ may be between 80% and 95% of the total weight of the pigment.

Other diffractive pigments are sold under the names Metalure® Prismatic by the company Eckart.

Other possible structures are Fe/Al/Fe or Al/Fe/Al.

The size of the diffractive pigment may be, for example, between 5 and 200 μm and better still between 5 and 100 μm, for example between 5 and 30 μm.

The thickness of the diffractive pigment particles may be less than or equal to 3 μm and better still 2 μm, for example about 1 μm.

3—Pigments or Reflective Particles

The term “reflective particles” denotes particles whose size, structure, especially the thickness of the layer(s) of which they are made and their physical and chemical nature, and surface state allow them to reflect incident light. This reflection may, where appropriate, have an intensity sufficient to create at the surface of the composition or of the mixture, when it is applied to the support to be made up, points of overbrightness that are visible to the naked eye, i.e. more luminous points that contrast with their environment by appearing to sparkle.

The reflective particles may be selected so as not to significantly alter the coloration effect generated by the coloring agents with which they are combined, and more particularly so as to optimize this effect in terms of color yield. They may more particularly have a yellow, pink, red, bronze, orange, brown, gold, silvery and/or coppery color or tint.

These particles may have varied forms and may especially be in platelet or globular form, in particular spherical.

Irrespective of their form, the reflective particles may or may not have a multilayer structure, and, in the case of a multilayer structure, for example at least one layer of uniform thickness, especially a reflective material.

When the reflective particles do not have a multilayer structure, they may be composed, for example, of metal oxides, especially titanium or iron oxides obtained via synthesis.

When the reflective particles have a multilayer structure, they may comprise, for example, a natural or synthetic substrate, especially a synthetic substrate at least partially coated with at least one layer of a reflective material, especially of at least one metal or metallic material. The substrate may be a monomaterial, multimaterial, organic and/or mineral substrate.

More particularly, it may be chosen from glasses, ceramics, graphite, metal oxides, aluminas, silicas, silicates, especially aluminosilicates and borosilicates, and synthetic mica, and mixtures thereof, this list not being limiting.

The reflective material may comprise a layer of metal or of a metallic material.

Reflective particles are described especially in documents JP-A-09188830, JP-A-10158450, JP-A-10158541, JP-A-07258460 and JP-A-05017710.

Again as an example of reflective particles comprising a mineral substrate coated with a layer of metal, mention may also be made of particles comprising a silver-coated borosilicate substrate.

Particles with a silver-coated glass substrate, in the form of platelets, are sold under the name Microglass Metashine REFSX 2025 PS by the company Toyal. Particles with a glass substrate coated with nickel/chromium/molybdenum alloy are sold under the name Crystal Star GF 550 and GF 2525 by this same company.

Particles comprising a metallic substrate such as silver, aluminum, iron, chromium, nickel, molybdenum, gold, copper, zinc, tin, magnesium, steel, bronze or titanium, may also be used, said substrate being coated with at least one layer of at least one metal oxide such as titanium oxide, aluminum oxide, iron oxide, cerium oxide, chromium oxide or silicon oxides, and mixtures thereof.

Examples that may be mentioned include aluminum powder, bronze powder or copper powder coated with SiO₂ sold under the name Visionaire by the company Eckart.

Metallic Pigments

The term “metallic pigment” covers powders based on aluminum, magnesium, copper, iron (steel), bronze, titanium or mica derivatives, generally used as additives, in particular for paints and inks.

The physical parameters that influence the “metallic” appearance imparted by said pigments are the mean sizes of the particles constituting the powder, their shape, their distribution and their orientation in the final formulation.

They generally have a particle size of between 5 and 25 μm and a flat flake or glitter flake shape or alternatively are in the form of microlamellae and are subdivided into two types, according to their wetting behavior in solvents:
leafing pigments, which remain at the surface of the formulation and become oriented parallel to the interfaces by forming a dense metallic layer, which gives the medium very high reflective power and excellent protection;
non-leafing pigments, which become oriented more or less parallel to the substrate, randomly and in the layer bottom of the preparation.

The composition according to the invention may comprise metallic pigments, preferably leafing pigments, preferentially of aluminum type, on condition that their content in the composition does not exceed 0.3% by mass relative to the total mass of the composition.

As examples of metallic pigments that may be used in the composition of the present invention, mention may be made of those from the company Eckart-Werke: Chromal® X (leafing aluminum powders, surface-treated with stearic acid and with a mean diameter of 9 μm) or Chromal® XV (leafing aluminum powders).

Standard Monochromatic Pigments:

According to one preferred embodiment of the invention, the coating compositions also comprise standard pigments, such as those commonly used in prior art paints and coatings. These pigments are responsible for the color and opacity of the coating. They are pulverulent solids, of very fine granulometry (generally less than 1 μm), mineral or organic, and well known to those skilled in the art. Examples that may be mentioned include titanium dioxide, zinc oxide, carbon black, iron oxides, ferric, potassium or sodium ferrocyanides, green chromium oxide, chromophores, auxochromes, azo dyes, phthalocyanins, etc. These very common pigments are therefore not described further.

III—Fillers

The fillers are in the form of mineral or organic, pulverulent solid materials. They improve certain rheological or physical properties, such as the hardness of the coating film, its impermeability or its corrosion resistance. They can also give the film uniformity and/or a matt effect.

These powders, with a particle size of greater than 1 μm, have little or no opacifying power and little dyeing power.

The fillers used in the compositions according to the present invention may be of lamellar, globular, spherical or fibrillar form or in any intermediate form between these defined forms.

The fillers according to the invention may or may not be surface coated, and in particular they may be surface-treated with silicones, amino acids, fluoro derivatives or any other substance that promotes the dispersion and compatibility of the filler in the composition.

Among the mineral fillers that may be used in the compositions according to the invention, mention may be made of oxides (silicas, quartz, amorphous silica, diatomaceous earths, etc.), silicates (talc, mica, kaolin, bentonite, calcium silicate, trimethyl siloxysilicate, etc.), carbonates (calcium carbonate, magnesium carbonate, magnesium hydrogen carbonate, dolomite, etc.), sulfates (barite, barium sulfate), hydroxyapatite, boron nitride, hollow silica microspheres (Silica Beads from Maprecos), glass or ceramic microcapsules; composites of silica and of titanium dioxide, such as the TSG series sold by Nippon Sheet Glass, and mixtures thereof.

A filler may be present in a composition in accordance with the invention in a proportion from about 0.1% to about 80% by weight of filler and preferably from about 1% to about 40% by weight of filler relative to the total mass of the composition. A filler that is suitable for use in the invention may be, for example, a filler whose mean particle size is less than 100 μm, especially in the range from 1 to 50 μm and preferably from 4 to 20 μm.

IV—Additives

A composition according to the invention may also comprise any kind of additive or adjuvant usually used in the field of coatings. These may be additives that give the coating powder and/or film certain specific properties, such as fluidity, flowability, etc. By way of example, the additives may be chosen from film-forming agents, and, where appropriate, film-forming auxiliaries, gums, semicrystalline polymers, antioxidants, anticorrosion agents, preserving agents and UV stabilizers, and mixtures thereof.

Any type of additive that contributes toward improving the properties of the powder for its use in aggregation technology may also be used. Mention may also be made of powders for infrared absorption, carbon black, mineral fillers for reducing the internal stresses, and flame-retardant additives. Additives for improving the mechanical properties (ultimate stress and elongation at break) of components obtained by melting powder comprising a composition according to the invention, may also be added. These fillers are, for example, glass fibers, carbon fibers, nanofillers, nanoclays and carbon nanotubes. The introduction of these fillers at the time of synthesis enables their dispersion and their efficacy to be improved.

It is a matter of routine operations for a person skilled in the art to adjust the nature and amount of the additives and/or fillers present in the compositions in accordance with the invention such that the desired esthetic properties and viscosity properties of these compositions are not thereby affected.

The present invention is illustrated with the aid of the examples of preferred compositions below. These examples do not in any way constitute a limitation of the present invention.

Mixing of the Ingredients to Manufacture the Composition

Advantageously, the mixing of the various ingredients, especially of the pigments and the base polymeric substance, to obtain the composition of the invention, is performed by dry blending.

In the examples described in the present patent application, a Henschel mixer is used, the spin speed of which is adjusted by the operator. Needless to say, any other type of mixer may be used, for instance a Magimix mixer.

In the case of the preparation of powders intended to be applied by “dipping”, the mixing is preferably performed at a spin speed from about 600 to 1200 rpm and preferably substantially equal to 900 rpm, for a time of 60 to 120 seconds and preferably substantially equal to 100 seconds.

In the case of preparation of powders intended to be applied by “electrostatic” spraying, the mixing is preferably performed at a spin speed from about 1500 to 2200 rpm and preferably substantially equal to 1800 rpm, for a time of 100 seconds.

The powders are then screened on a screen with a mesh size of 355 μm.

The mean diameter of the powder particles of the composition according to the invention is advantageously between 10 μm and 1 mm.

Process for the Coating/Manufacture of an Article

During the coating process according to the invention, for example by dipping in a fluidized bed, the article is covered in the bed with a film of powder. The thickness of the powder film may be up to 2 mm, and is advantageously between 0.1 and 0.6 mm. The article may optionally be subjected to heating or baking. The powder melts, forms a film and forms the coating.

Needless to say, the fluidized-bed dipping device is given merely as an example, and any other device for the at least partial manufacture of an article by melt-aggregating at least one coat of powder, or of coating an article with a film, such as electrostatic spraying or dusting, may also be used in the process of the invention. The process according to the invention especially includes powder aggregation techniques by melting or sintering mediated by radiation, for instance a laser beam (laser sintering), infrared radiation or UV radiation or any source of electromagnetic radiation that can melt the powder to manufacture articles, a part of an article and/or the coating thereof.

The coatings of the examples described below are applied by dipping onto 100×50×3 mm steel plates.

The application conditions comprise:
heating of the plates for 10 minutes at 330° C., followed by
dipping them for 4 seconds, and then
cooling them in air and/or water (after 1 minute 20 seconds).

The type of cooling has an impact on the dispersion of the pigments at the surface of the article and within the thickness of the coating film. Dipping the coated article in water sets the structure and prevents the development of large spherolites, whereas cooling in air leads to crystalline structures that can grow.

The surface aspect is glossier if the cooling is performed in water.

However, on the set of plates cooled with water (after 1 minute 20 seconds), the metal marking tests show that the metal marking is greater than for the plates cooled in air. For the process according to the invention, the preferential cooling mode is thus performed in air.

Metal-Marking Resistance Test or Felt Test

To evaluate the metal marking, the felt test is used, which allows the resistance to friction of various surfaces or coatings by abrasion to be measured and classified. This procedure applies to all the coatings and metal surfaces.

Principle:

The test consists in rubbing a coating or surface part of an article made of polyamide (for example polyamide 11) with a dry felt or piece of baize. The felt effects regular to-and-fro actions, at a constant pressure, up to the point of apparent degradation of the surface (coating/surface part of the article).

Apparatus:

In the profession, this test is often performed by hand with a piece of paper.

The device used here is derived from the leather industry. It is known as a Usometer. It is provided by the company EMI. Its automation (40 to-and-fro actions per minute) ensures better reproducibility in the tests.

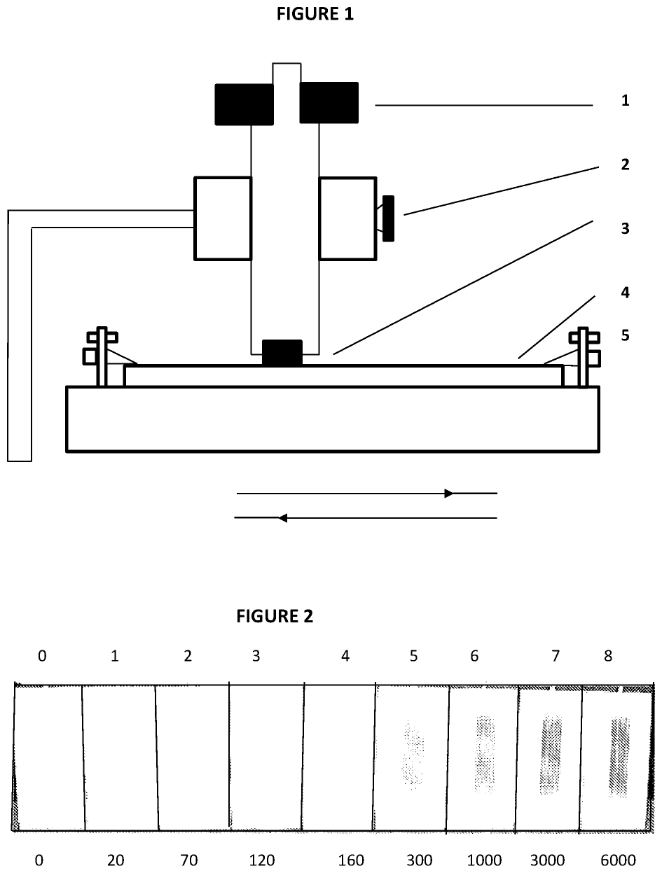

FIG. 1 shows this metal-marking resistance test device used in the examples.

The felts or pieces of baize (indicated by the number 3 in FIG. 1) used are 15×15 mm squares of standardized white felt, of reference Veslic—C4500/IUF450, art No. 701 (from Germany).

Procedure:

A coating is prepared under the application conditions defined previously, with special attention being paid to the drying/cooling conditions and the preconditioning conditions.

The surface of the film obtained must be free of any defects that might initiate abnormal and advanced degradation during the test (no dust or aggregates, etc.).

About 24 hours after the application of the coating, the plate with the coating (referenced 4 in FIG. 1) is placed on the machine and blocked by two side jaws 5.

A weight 1 of 1 kg is placed on a “felt-holder” column, fixed by means of a clamp 2. In the case of the examples, the column weighs 0.5 kg and the column clamp weighs 0.5 kg.

To fix the felt, the column is released by slackening the appropriate clamp (2).

A felt 3 is fixed under the column, and the column is then retightened, such that the felt touches the coating 4 to be tested.

After checking that the counter has been zeroed, the to-and-fro actions are started by flicking the on/off switch.

The test is stopped when 1000 or 3000 cycles have been performed.

A) Reference Scale

Test on a grade with a high content of aluminum pigment (greater than 0.3%), very sensitive to metal marking. An increasing number of cycles (0 to 6000 cycles) is applied and, at each level of metal marking, is given a note between 0 and 8.

0=0 cycles=perfect, no metal marking

8=6000 cycles=very strong metal marking

FIG. 2 shows this reference scale which attributes a grade to each level of metal marking.

| | Level of metal marking | | | | | | | | |
|---|---|---|---|---|---|---|---|---|---|
| | 0 | 1 | 2 | 3 | 4 | 5 | 6 | 7 | 8 |
| Number of cycles | 0 | 20 | 70 | 120 | 160 | 300 | 1000 | 3000 | 6000 |

In the examples of the present patent application, various grades are tested at 1000 and 3000 cycles and are classified according to this notation.

B) Metal Marking Tests:

The formulations tested in the various tests and examples of the application use one or more of the following ingredients:

Pigments with effects:
Iriodin 119 (from the company Merck): pigments with effects formed from mica glitter flakes coated with TiO₂, with a particle size that may range from 10 to 60 μm;
Iriodin 120 (from the company Merck): pigments with effects formed from mica glitter flakes coated with TiO₂, with a particle size that may range from 5 to 20 μm;
PX 2001, PX 1320: nacres from the company Eckart

Standard Monochromatic Pigments:

Black (PK 3097), white (zinc oxide), titanium RHD2, red iron oxide 130, Yellow light 6R.

Metallic Pigments:

Non-Leafing Aluminum:
Sillux 501 (from the company Eckart): non-leafing aluminum glitter flakes with a double coating: silica (SiO₂) and organic, and a mean diameter of 20 μm;
PCR 212 (Eckart): glossy pigments formed from non-leafing aluminum glitter flakes coated with silica (SiO₂) and with a mean diameter of 48 μm;
Alu 21326/A (Eckart): non-leafing aluminum glitter flake, coated with silica.

Leafing Aluminum:
Chromal X (from the company Eckart-Werke): leafing aluminum powders, surface-treated with stearic acid, and with a mean diameter of 9 μm;
Chromal XV (from the company Eckart-Werke): leafing aluminum powders, of stainless-steel appearance.

Additives:

Irganox 1098: antioxidant commonly used in thermoplastic coating compositions. Its chemical formula is: N,N′-hexane-1,6-dihylbis(3-(3,5-di-tert-butyl-4-hydroxy-phenylpropionamide.

Table 1 below shows the results of the metal-marking resistance tests for coatings made from different formulations based on polyamide 11 with a relative viscosity in solution that is in the range from 0.9 to 1.2 (viscosity measured at 25% by mass as a solution in meta-cresol).

For each test, only the pigments used and the content thereof (as a percentage) in the polyamide 11 are thus stated in table 1 (“Formulation” column).

The results of the felt tests (levels of metal marking MM between 0 and 8) after 1000 and 3000 cycles are indicated in the corresponding columns of table 1.

TABLE 1

| | | Level of MM (from 1 to 8) after: | |
|---|---|---|---|
| Test No. | Formulation | 1000 cycles | 3000 cycles |
| 1 | 0.16% Sillux 501 | High (gray) 5 | Very high |
| | 0.24% Iriodin 119 | | (black) 8 |
| | 0.025% Pigment noir | | |
| | 0.21% Irganox 1098 | | |
| 2 | 0.3% Sillux 501 | High (gray- | Very high |
| | 0.5% Iriodin 119 | black) 6 | (black) 7 |
| | 0.15% Pigment noir | | |
| | 0.13% Irganox 1098 | | |
| 3 | 0.18% Sillux 501 | High (gray- | High (gray- |
| | 0.14% PCR212 | black) 5 | black) 6 |
| | 0.48% Iriodin 119 | | |
| 4 | 0.1% Alu21326 | High (gray) 4 | High (gray- |
| | 0.06% PCR 212 | | black) 5 |
| | 0.07% Pigment noir | | |
| | 0.24% Iriodin 119 | | |
| 5 | 0.15% PCR212 | High (gray) 5 | Very high |
| | 0.22% Iriodin 119 | | (black) 7 |
| | 0.15% Pigment Noir | | |
| 6 | 0.5% Alu21326 10 pm | High (black) 5 | Very high |
| | 0.1% Iriodin 120 | | (black) 7 |
| | 0.13% Irganox 1098 | | |
| 7 | 0.12% Pigment noir | 0 | 0 |
| 8 | 0.04% Pigment noir | 0 | 0 |
| | 0.3% Irganox | | |
| 9 Example | 0.46% Pigment noir | 0 | Slight trace |
| according to | 0.55% Iriodin 120 | | black 1 |
| the invention | | | |
| 10 | 0.45% Chromal X | Low(gray) 2 | Very high |
| | 0.3% Iriodin 119 | | (black) 8 |
| 11 Example | 0.2% Chromal XV | No metal | 0 |
| according to | 0.3% Iriodin 119 | marking | |
| the invention | 0.13% Irganox 1098 | | |
| | 0.12% Pigment noir | | |

C) Conclusion

The grades without aluminum and without nacres show no metal marking: tests 7 and 8.

The grades with non-leafing aluminum pigments (Sillux 501/PCR 212) mark substantially:

tests 1 to 6.

The formulations with an amount of leafing aluminum (Chromal type) of greater than 0.3% mark substantially: test 10.

The formulations without aluminum metal pigment (example according to the invention: test 9) or with a small amount of leafing aluminum (content of less than or equal to 0.3% by mass relative to the total mass of the formulation) of Chromal type mark little: example/test 11 according to the invention. This last formulation according to the invention gives very good metal-marking resistance results: no metal marking is observed, even after 3000 cycles in the felt test.

These examples show that the use of nacres and limitation of the content of aluminum pigments (preferably chosen from leafing aluminums) in the coating compositions according to the invention make it possible to obtain a coating with a metallic appearance that is stable in the long term and resistant to metal marking.

For the formulations according to the invention (examples 9 and 11), no blistering, no other surface defects and no loss of hue are observed.

Tests 12 to 27:

Formulations are prepared with leafing aluminum pigments (Chromal X, Chromal XV) and non-leafing aluminum pigments (Sillux 501, Alu 21326/A) according to the same formulation, but with different contents of aluminum (0.3%; 0.6% and 0.9%).

The base polymer used for all the formulations 12 to 27 is polyamide 11 (PA 11) with a relative viscosity substantially equal to 0.95 (measured at 0.25% by mass as a solution in meta-cresol).

TABLE 2

| | 12 | 13 | 14 |
|---|---|---|---|
| PA 11 | qs 100 | qs 100 | qs 100 |
| Water | 0.3 | 0.3 | 0.3 |
| Zinc oxide | 0.15 | 0.15 | 0.15 |
| Titanium RHD2 | 0.15 | 0.15 | 0.15 |
| Red iron oxide 130 | 0.01 | 0.01 | 0.01 |
| Yellow light 6R | 0.03 | 0.03 | 0.03 |
| Alu Sillux 501 | 0.3 | 0.6 | 0.9 |

Examples 15, 16 and 17 adopt the same formulations, replacing the Alu Sillux 501 by Alu Chromal X; examples 18, 19 and 20 replace it with Alu 21326/A; and examples 21, 22 and 23 replace it with Alu Chromal XV.

The coatings are applied by dipping onto 100×50×3 mm plates.

Application Conditions:

Heating of the steel plates: 10 minutes at 330° C., and then 4 seconds of dipping, followed by cooling in air and water after 1 minute 20 seconds.

The formulations of tests 24 to 27 of table 3 below also comprise 0.3% by mass of a pigment with an effect (Iriodin 119).

TABLE 3

| Test No.: | 24 | 25 | 26 | 27 |
|---|---|---|---|---|
| PA 11 | qs 100 | qs 100 | qs 100 | qs 100 |
| Water | 0.3 | 0.3 | 0.3 | 0.3 |
| Zinc oxide | 0.15 | 0.15 | 0.15 | 0.15 |
| Iriodin 119 | 0.3 | 0.3 | 0.3 | 0.3 |
| Sillux 501 | 0.3 | — | — | — |
| Chromal X | — | 0.3 | — | — |
| Chromal XV | — | — | 0.3 | — |
| Alu 21326/A | — | — | — | 0.3 |

Tables 4 and 5 (tests 14 to 27) below indicate, for the various contents of metallic pigments and/or pigments with effects, the results of the metal marking tests, depending on whether the cooling of the coating was performed in air or with water.

The appearance of the coating obtained with these compositions is evaluated by a panel of experienced experts:
the metallic appearance is graded on a scale from 1 to 10, the grade 1 corresponding to the poorest metallic appearance and the grade 10 to the greatest metallic appearance;
the number of fish eyes is counted (after cooling in water or air).

These tests confirm that the metal marking is greater on the plates cooled in water than in air.

It is observed that the surface defects such as the fish eyes are greater on the coatings comprising non-leafing aluminum.

The comparison of tables 4 and 5 shows that the metal marking is much greater on the non-leafing pigments than on the leafing pigments.

TABLE 4

| | | | | Metal | | | | |
|---|---|---|---|---|---|---|---|---|
| | | | | marking | Metal | | | |
| | | Alu | | (water) | marking | Metallic | Fish | Fish |
| | Test | pigment | Pigment | (1000 | (air) (1000 | appearance | eyes | eyes |
| | No. | used | content | cycles) | cycles) | (/10) | (water) | (air) |
| With | 14 | Sillux | 0.9% | Very high | Very high | 10 | >20 | >20 |
| non-leafing | | 501 | | (black) 8 | (black) 8 | | | |
| aluminum | 13 | Sillux | 0.6% | Very high | Very high | 9 | 3 | 5 |
| | | 501 | | (black) 8 | (black) 8 | | | |
| | 12 | Sillux | 0.3% | High | Low (gray) | 5 | 7 | 5 |
| | | 501 | | (black) 7 | 3 | | | |
| | 24 | Sillux | 0.3% | High | No metal | 8 | 3 | 2 |
| | | 501 | | (black) 6 | marking 0 | | | |
| | | Iriodin | 0.3% | | | | | |
| | | 119 | | | | | | |
| | 17 | 21326/A | 0.9% | Very high | High (gray- | 9 | 17 | 8 |
| | | | | (black) 8 | black) 6 | | | |
| | 16 | 21326/A | 0.6% | Very high | Low (gray) | 8 | 2 | 5 |
| | | | | (black) 8 | 3 | | | |
| | 15 | 21326/A | 0.3% | Slight | Trace gray | 4 | 4 | 6 |
| | | | | trace gray | 2 | | | |
| | | | | 1 | | | | |
| | 25 | 21326/A | 0.3% | Slight | Slight trace | 9 | 6 | 3 |
| | | Iriodin | 0.3% | trace gray | gray 1 | | | |
| | | 119 | | 1 | | | | |

The addition of pigments with an effect (Iriodin) makes it possible to reduce the metal marking and the coating defects (fish eyes) for the formulations comprising non-leafing aluminum.

TABLE 5

| | | | | Metal marking | Metal | Metallic |
|---|---|---|---|---|---|---|
| | Test | Alu pigment | Pigment | (water) | marking (air) | appearance |
| | No. | used | content | (1000 cycles) | (1000 cycles) | (/10) |
| With | 20 | Chromal X | 0.90% | High (black) 6 | Slight trace | 8 |
| leafing | | | | | gray 1 | |
| aluminum | 19 | Chromal X | 0.60% | High (black) 6 | Slight trace | 5 |
| | | | | | gray 1 | |
| | 18 | Chromal X | 0.30% | Slight trace | No metal | 9 |
| | | | | gray 1 | marking 0 | |
| | 26 | Chromal X | 0.30% | Slight trace | No metal | 10 |
| | | Iriodin 119 | 0.30% | gray 1 | marking 0 | |
| | 23 | Chromal XV | 0.90% | Moderate | Low (gray) 3 | 8 |
| | | | | (gray) 4 | | |
| | 22 | Chromal XV | 0.60% | Moderate | Low (gray) 3 | 7 |
| | | | | (gray) 4 | | |
| | 21 | Chromal XV | 0.30% | Slight trace | No metal | 5 |
| | | | | gray 1 | marking 0 | |
| | 27 | Chromal XV | 0.30% | Slight trace | No metal | 10 |
| | | Iriodin 119 | 0.30% | gray 1 | marking 0 | |

Irrespective of the type of aluminum in the formulations, the use of pigments with an effect, combined with the use of a limited amount of aluminum pigments (less than or equal to 0.3%), makes it possible to increase the metallic appearance while at the same time not having any metal marking, even in the long term.

Observation of the surface appearance by microscope (optical microscope or SEM):

Different dispersion of the leafing and non-leafing pigments is observed at the surface of the plates. The particles of the non-leafing pigments are coarser and give a more glittery effect. The leafing pigments are dispersed at the surface in the form of a large number of small particles, and create a mirror effect and a more uniform surface.

Examples of Formulations According to the Invention:

Formulation 28 uses both nacres (PX 2001 and PX 1320) and a leafing aluminum pigment (Chromal XV):

Formulation 28

| PA 11 | qs 100 |
|---|---|
| Visco | 0.95 |
| Water | 0.3 |
| Zinc oxide | 0.15 |
| Irganox 1098 | 0.15 |
| Chromal XV | 0.1 |
| PX 2001 | 1 |
| PX 1320 | 0.2 |

Formulation 29 (without aluminum pigment) uses both nacres (Iriodine 500, 502, 511) and a higher content of pigments (black):

Formulation 29

| PA 11 | qs 100 |
|---|---|
| Visco | 0.95 |
| Water | 0.3 |
| Zinc oxide | 0.15 |
| Iriodine 502 | 0.014 |
| Iriodine 500 | 0.045 |
| Black PK 3097 | 0.11 |
| Iriodine 111 | 0.15 |

| | Coating obtained | | | | | |
|---|---|---|---|---|---|---|
| | | | | | | Stable |
| Formu- | | | | Metal marking tests | | metallic |
| lation | | | Fish | 1000 | 3000 | appear- |
| No. | Pitting | | eyes | cycles | cycles | ance? |
| 28 | 6/18 | (water) | — | Very low 1 | Very low 1 | Yes |
| | 7/18 | (air) | | | | |
| 29 | | | — | Very low 1 | Very low 1 | Yes |
| | 1/18 | (air) | | | | |

The coatings obtained according to the application process described previously, starting with the formulations 28 and 29 according to the invention:
cover the edges perfectly,
show very little or no pitting (evaluation mode: examination of the number of intersections showing the defect: number of pits/18 intersections), and
no fish eyes are observed (evaluation mode: fish eyes counted when their size is significant, diameter greater than about 0.5 mm).

The felt tests performed on these coatings show that they are very resistant to metal marking. These coatings according to the invention have a metallic appearance that is stable over time, after 1000 cycles, 3000 cycles and more.

1. A pulverulent composition for the manufacture of articles with a metallic appearance that is stable over time and that shows improved resistance to metal marking, said composition comprising:
a polyamide powder, said polyamide powder present in an amount from 50% to 99.9% by mass of the composition,
a pigment powder, said pigment power present in an amount from 0.1% to 5% by mass of the composition, said pigment powder comprising at least one pigment with an optical effect selected from a nacreous interference pigment,
a metallic leafing pigment powder, said metallic leafing pigment powder present in an amount not exceeding 0.3% by mass of the composition, said metallic leafing pigment powder comprising at least one metallic leafing pigment that is not an effect pigment and is selected from aluminum, copper, copper or aluminum alloys, and mixtures thereof,
wherein said composition has been prepared by dry blending the polyamide powder, the pigment powder, and the metallic leafing pigment powder.

2. The composition as claimed in claim 1, in which said polyamide powder is selected from the group consisting of: PA 11, PA 12, PA 6.10, PA 6.12, PA 6.14, PA 6.18, PA 10.10, PA 10.12, copolyamides, and mixtures thereof.

3-6. (canceled)

7. The composition as claimed in claim 1, in which the nacreous interference pigment is selected from the group consisting of: titanium mica coated with an iron oxide, mica coated with bismuth oxychloride, titanium mica coated with chromium oxide, titanium mica coated with an organic dye, nacreous pigments based on bismuth oxychloride, mica particles at the surface of which are superposed at least two successive layers of metal oxides and/or of organic dyestuffs, and mixtures thereof.

8-10. (canceled)

11. The composition as claimed in claim 1, in which the metallic leafing pigment is leafing aluminum.

12. The composition as claimed in claim 1, in which said at least one polymer is polyamide 11, said pigment powder is present in an amount from 0.1% to 1% by mass of the composition, said metallic leafing pigment is aluminum.

13. The composition as claimed in claim 1, also comprising at least one additive and/or at least one filler and/or at least one monochromatic pigment.

14. The composition as claimed in claim 13, in which said at least one additive is chosen from antioxidants, heat stabilizers, anticorrosion agents, fluidity or flowability enhancers, film-forming agents, film-forming auxiliaries, gums, semicrystalline polymers, preserving agents and UV stabilizers, and mixtures thereof.

15. The composition as claimed in claim 13, in which said at least one filler is chosen from oxides, silicas, quartz, amorphous silica, diatomaceous earths; silicates, talc, mica, kaolin, bentonite, calcium silicate, trimethyl siloxysilicate; carbonates, calcium carbonate, magnesium carbonate, magnesium hydrogen carbonate, dolomite; sulfates; hydroxyapatite, boron nitride, hollow silica microspheres; glass or ceramic microcapsules; composites of silica and of titanium dioxide, and mixtures thereof.

16. A coating with a metallic appearance that is stable over time and that is resistant to metal marking, said coating being derived from the melting of at least one coat of powder composition as claimed in claim 1.

17. A process for manufacturing at least a surface part of an article by powder melt-aggregation, said powder comprising a composition as claimed in claim 1.

18. The process as claimed in claim 17, in which the powder melt-aggregation is mediated by electromagnetic radiation.

19. The process as claimed in claim 17, in which said surface part of the article comprises at least one coating formed by the powder melt-aggregation, said coating having a metallic appearance that is stable over time and that is resistant to metal marking, said process comprising at least the following steps:
mixing the components of said composition,
screening the powder thus obtained,
heating at least one surface of the article to be covered,
at least partially dipping the article in said composition,
cooling the article thus covered in air and/or with water.

20. (canceled)

21. A manufactured article having at least a surface part with a metallic appearance that is stable over time and that shows improved resistance to metal marking, said surface part being obtained by melting at least one coat of powder composition as claimed in claim 1.

22. (canceled)

23. A dishwasher basket comprising a coating obtained from a powder composition as claimed in claim 1.
